(19) United States
(12) Patent Application Publication
(10) Pub. No.: US 2020/0029738 A1
(43) Pub. Date: Jan. 30, 2020

(54) HERB AND SPICE GRINDER AND BLADES FOR SUCH HERB AND SPICE GRINDERS

(71) Applicant: Marcel Pierre RIZZOTTI, The Woodlands, TX (US)

(72) Inventor: Marcel Pierre RIZZOTTI, The Woodlands, TX (US)

(21) Appl. No.: 16/523,603

(22) Filed: Jul. 26, 2019

Related U.S. Application Data
(60) Provisional application No. 62/703,716, filed on Jul. 26, 2018.

(51) Int. Cl. A47J 42/26; A47J 42/16; A47J 42/28; A47J 42/30

(52) U.S. Cl. CPC A47J 42/26; A47J 42/30; A47J 42/28; A47J 42/16

(57) ABSTRACT

An herb and spice grinder has a plurality of sections that are removably connected together. A hole is formed at the outer periphery of each of the plurality of sections. The plurality of sections can be rotated relative to one another so that the holes align to form a passageway. The bolt of a lock can be inserted through the passageway so as to prevent the sections from rotating relative to one another and to prevent the sections from being separated from one another. As a result, undesired access to the contents of such herb and spice grinder is effectively prevented. Preferably, rotation of a top section relative to an intermediate section causes a grinding of the herb or spice. The ground material passes through openings in the intermediate section to be stored in a receptacle formed in a bottom section. A blade for a grinder is also disclosed.

### RELATED U.S. APPLICATIONS

The present application claims priority to U.S. Provisional Application No. 62/717,716, filed on Jul. 26, 2018, presently pending.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

### 1. Field of the Invention

The present invention relates to herb and spice grinders. More particularly, the present invention relates to hand-held herb and spice grinders in which one section can rotate relative to another section so as to achieve a grinding effect. The present invention also relates to blades as used in association with such herb and spice grinders.

### 2. Description of Related Art Including Information Disclosed Under 37 CFR 1.97 and 37 CFR 1.98

Hand-held herb and spice grinders are well known, and commonly used for grinding and storing solid spices, such as peppercorns and other seeds. Typical grinders comprise a static element which has a central bore. An array of teeth project inwardly from the surface of the bore. Within the bore, there is a rotatable element which has radially outwardly projecting vanes. Peppercorns and other spice seeds are trapped between the vanes and the teeth and ground into a powder when the rotatable element is turned. The powder then falls from the grinder, such as directly onto a plate or cooking dish.

While serving adequately to store as well as manually grind spice seeds, such a grinder cannot be used in other applications wherein herbs must be both stored and ground. There are several reasons for this. For example, the typical spice grinder is able to hold and store the seeds while allowing the seeds the fall through small passageways into the grinding element before being discharged as ground and pulverized spices. However, herbs consisting of leaves and relatively long strands do not readily fall through the apertures of the storage container into the grinding element.

There are instances where the herbs, leaves, or the like are desirably pulverized and ground into a finer material. The herbs are typically purchased in a non-ground state and stored in this manner. Moreover, a specific amount and quantity or dose may be required if the herbs used as medicine, or a particular amount may be desired for the intended purpose. Another example is the grinding of tobacco leaves in an amount desirable for rolling a cigarette or for placement in a pipe so as to be smoked. Typical spice grinders and the like do not allow one to take these factors into consideration.

Presently, such herbs are stored in a manner in which their strong and unique odor may escape from the container and into the area surrounding the stored herbs, such as filling one's automobile, room, etc. with the odor which may be undesirable. The desired amount of herb must be extracted from the storage container and then manually ground using other means or a completely separate grinder. This is not only inconvenient, but once again the unique and strong odor of the herb is not adequately contained when using the cutting and grinding mechanism and methods currently available.

Accordingly, there is a continuing need for a device which can both store the herb, as well as serving as a grinding device so as to cut and grind the herb to the desired level, while minimizing the odors emanating from the device.

Additionally, when spices and herbs are ground within the grinding device, it can be very easy to access the contents which are being stored. As such, children, and other persons, can often access the contents of such a grinding device, against the wishes of the person that has ground the herbs and spices. In certain circumstances, the consumption of such ground herbs and spices can be harmful to children. As such, a need has developed so as to provide an herb and spice grinder which can prevent undesired persons from accessing the contents of the grinder.

In the past, various patents have issued relating to such herb and spice grinders. For example, U.S. Pat. No. 8,695,906, issued on Apr. 15, 2014 to M. Hainbach, teaches a combination herb storage, grinder and pouring container. A cap is removably attached to the grinding and pouring cup. An herb storage receptacle is nested within the cup end cap. The receptacle defines an herb storage compartment having grinding elements extending therefrom so as to be disposed adjacent to the grinding elements of the cup, so as to selectively grind herbs placed between the storage receptacle and the cup. The cup and cap are removably locked to one another, and an airtight and watertight seal is formed between the cup and storage receptacle.

U.S. Pat. No. 9,241,597, issued on Jan. 26, 2016 to D. Dukat, describes an apparatus for herb grinding. The herb grinder has four tiers for cutting and collecting the dried herbs. The grinder has arched cutters, a tier for collecting the cut herbs, and an additional tier for separating the cut herbs from the ultra-fine pollen particles.

U.S. Pat. No. 8,783,595, issued on Jul. 22, 2014 to Stephen et al., shows a spice grinder having a bottle and a grinder unit which is screwed on to the bottle. The grinder unit comprises a fixed component and a rotatable component. The components have teeth which face one another across a grinding gap. The component has one or more ramps on the inside thereof and the bottle has one or more external ramps. Each ramp comprises a camming surface and a locking surface which intersect. The ramp also includes a camming surface and a locking surface. When the grinder unit is screwed on to the bottle, the ramps ride over one another until the surfaces clear one another and the surfaces snap into face-to-face contact to prevent the grinder from being rotated in the direction which unscrews it from the bottle.

U.S. Pat. No. 8,083,167, issued on Dec. 27, 2011 to Nojan et al., provides a portable leaf grinding device that is used to grind a substance such as a plurality of compacted leaves into a multiplicity of leaf particles. The leaf grinding device has a circular, a cone-shaped hollow structure that is releasably attached to the cap, and a container that is also attached to the cap. The circular cap has an upper grinding disk attached thereto. The upper grinding disk has a plurality of downwardly-extending leaf grinding blades. The upper grinding disk interacts with a lower grinding disk which is attached to the structure which also includes a plurality of upwardly-extending grinding blades and a plurality of bores. When the circular cap is rotated, the blades on the two grinding disks interact with each other to produce the multiplicity of leaf particles. The leaf particles can either be stored in the container for later use or used immediately as they exit from the structure.

U.S. Patent Application Publication No. 2017/0319009, published on Nov. 9, 2017 to Seckel et al., teaches an herb grinder that is used for grinding, storing and dispensing plant materials, such as herbs, flowers, plants, seeds, and leaves. The modular grinder is assembled in the multiple configurations.

U.S. Pat. No. 9,510,709, published on Dec. 6, 2016 to Wilson et al., shows herb chopper which includes a bottle, an upper chopper, a lower chopper, an agitator, and a dust cap. The bottle is used to hold a herb to be ground. The upper chopper is positioned inside of and opposite to the lower chopper and can rotate with respect to the lower chopper. The bottle is positioned on the upper chopper partially inside the lower chopper. The bottle is rotated relative to the lower chopper causing the herb leaves to be chopped by the upper and lower choppers and dispensed out of the chopper through dispensing holes formed in the lower chopper.

U.S. Pat. No. 4,280,666, issued on Jul. 28, 1981 to R. H. Jones, provides a hand-held granulator for peppercorns, salts, nuts, spices, and foliage greens. A first cylindrical container portion with a removable cap stores unground material and a second cylindrical container portion stores ground materials. Two sealingly engaged central flanges with an interchangeable grinding screen therebetween receive the first and second containers on either side with the first in sliding rotational engagement and the second in fixed engagement. A twisting motion imparted by the hands results grinding of the materials between the first container portion and the screen. Ground material passes through the grinding screen and is either retained in the second cylindrical container or dropped free.

U.S. Pat. No. 3,371,874, issued on Mar. 5, 1968 to Reeves et al., describes a peppermill. This peppermill is used for grinding peppercorn.

U.S. Patent Application Publication No. 2016/0353931, published on Dec. 8, 2016 to J. C. Liu, discloses a coffee grinding device that includes a base, a tubular part connected to the top of the base, and a driving member received in the tubular part and driven by the base. A male grinder is connected to the driving member with a female grinder adjustably located above the male grinder. A threaded tube is threadedly connected to the tubular part and defines a gap between the underside of the threaded tube and the female grinder to adjust the sizes of coffee beans to be ground between the male and female grinders.

It is an object of the present invention to provide an herb and spice grinder that is effective for both grinding herbs and spices.

It is another object of the present invention to provide an herb and spice grinder that can effectively store the ground herbs and spices while minimizing any odors emitted therefrom.

It is a further object of the present invention to provide an herb and spice grinder which can be locked so as to prevent unintended access to the contents of the herb and spice grinder.

It is another object of the present invention to provide an herb and spice grinder that is easy to use and relatively inexpensive.

It is another object of the present invention to provide a blade for an herb and spice grinder which more effectively shreds material that comes into contact with.

These and other objects and advantages of the present invention will become apparent from a reading of the attached specification and appended claims.

### BRIEF SUMMARY OF THE INVENTION

The present invention is an herb and spice grinder having a first section with a first plurality of blades on a bottom side thereof, a second section removably connected to the bottom side of the first section, the second section having a central collection pocket with a second plurality of blades therein, the second plurality of blades extending upwardly toward said first section, and a third section removably connected to a bottom side of the second section. The third section has a receptacle formed therein. Each of the first, second third sections have a hole formed therethrough, the holes being alignable so as to allow for the receipt of a lock member through the holes.

In an embodiment, the third section is threadedly connected to the second section.

In an embodiment, the first section has a recess formed in the bottom side thereof. The central collection pocket of the second section has a shoulder extending upwardly therefrom, wherein an O-ring is interposed between the shoulder of the second section and a wall of said recess of the first section. In this embodiment, the first section can be separated from the second section by simply pulling the first section away from the second section.

In an embodiment, a plurality of openings are formed through the central collection pocket, the plurality of openings being located adjacent the second plurality of blades.

In an embodiment, the first, second and third sections each have a generally triangular shape with rounded corners. Preferably, a hole is formed adjacent each of the rounded corners of each of the first, second and third sections. In one embodiment, one hole of each of the first, second and third sections is oval-shaped.

In an embodiment, an indentation is formed at each of the rounded corners of each of the first, second and third sections. This indentation in each of the rounded corners of the various sections facilitates the ability to grip and manipulate the various sections of the herb and spice grinder of the present invention.

In an embodiment, the grinder may also have a cutter positioned centrally of the first plurality of blades of the aid first section. Preferably, the cutter has a pinwheel shape. Specifically, the cutter, in cross-section, has three pointed ends with an S-shaped edge extending respectively between the three pointed ends.

In an embodiment, each of the first plurality of blades and second plurality of blades include a longitudinal member having a cross-section having a first curved end surface, a pair of curved side surfaces extending from ends of the first curved end surface, a pair of second curved end surfaces extending inwardly from the ends of the pair of curved side surfaces, and a central curved end surface positioned between the pair of second curved end surfaces.

In an embodiment, the first plurality of blades of the first section include a first circular array and a second circular array spaced apart from the first circular array, and the second plurality of blades of the second section include a first circular array and a second circular array spaced apart from the first circular array. The second plurality of blades of the second section intermesh with the first plurality of blades of the first section.

The present invention is also an herb and spice grinder including a plurality of sections that are removably connected together, the plurality of sections defining an interior for grinding and storage of the herb or spice, each of the plurality of sections having a hole formed therethrough, the holes of the plurality of sections being alignable so as to form a passageway through said plurality of sections, and a lock having a bolt. The bolt is received in the passageway so as to prevent access to the interior of the plurality of sections.

In an embodiment, the plurality of sections include a first cap section, a second section having a plurality of openings formed therethrough, and a third section having a receptacle formed therein. The grinder may also include a first plurality of blades formed on a bottom side of the first cap section, and a second plurality of blades formed on a top side of the second section, the first plurality of blades intermeshing with the second plurality of blades.

In an embodiment, the third section is threadedly engaged with the second section.

In an embodiment, the first cap section has a recess formed in the bottom thereof, and the second section has a shoulder extending upwardly therefrom. An O-ring is interposed between the shoulder of the second section and a wall of the recess of the first cap section, the first cap section being rotatable relative to the second section.

In an embodiment, each of the plurality of sections are a generally-triangular member having rounded corners, wherein each rounded corner has a curved indentation, and wherein the hole of each of the plurality of sections is positioned adjacent each of the rounded corners.

In an embodiment, the lock is a padlock.

The present invention is also a blade for an herb and spice grinder including a longitudinal member having a cross-section having a first curved end surface, a pair of curved side surfaces extending from ends of the first curved end surface, a pair of second curved end surfaces extending inwardly from the ends of the pair of curved side surfaces, and a central curved end surface positioned between the pair of second curved end surfaces.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a side elevational view of the herb and spice grinder of the present invention with a lock included therein.

FIG. 2 is an upper perspective view of the assembled herb and spice grinder of the present invention.

FIG. 3 is an upper exploded perspective view of the herb and spice grinder of the present invention.

FIG. 4 is a bottom exploded perspective view of the herb and spice grinder of the present invention.

FIG. 5 is a bottom view of the first section of the herb and spice grinder of the present invention.

FIG. 6 is a plan view of the second section of the herb and spice grinder of the present invention.

FIG. 7 is an enlarged view of a blade as used in the first and second sections of the herb and spice grinder of the present invention.

FIG. 8 is a plan view of a cutter as used in the first section of the herb and spice grinder of the present invention.

### DETAILED DESCRIPTION OF THE INVENTION

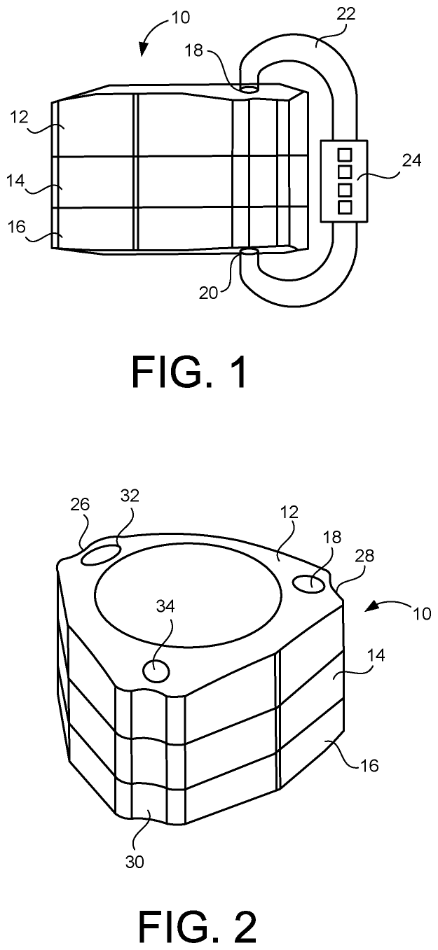

Referring to FIG. 1, there is shown the herb and spice grinder 10 in accordance with the teachings of the present invention. The herb and spice grinder 10 includes a first section 12, a second section 14, and a third section 16 that are removably connected together. Each of the sections will have an outer periphery. A hole is formed at the outer periphery of each of the sections 12, 14 and 16. The sections 12, 14 and 16 are rotatable with respect to each other so that the holes align with each other. In FIG. 1, it can be seen that there is a hole 18 that aligns with a corresponding hole of the second section 12 and with a hole 20 of the third section 16, thus forming a passageway therethrough. When the holes 18 and 20 (along with the hole of the second section 14) are aligned, it is possible to install a lock 22. The bolt of the lock 22 can extend through the respective holes of the sections 12, 14 and 16.

In FIG. 1, it can be seen that there is a combination lock 24 that is cooperative with the bolt of the lock 22 so that the user can set a desired combination. The lock 22 can be properly installed through the holes of the sections 12, 14 and 16 and locked so as to prevent undesired access to the contents of the herb and spice grinder 10. As such, the herb and spice grinder of the present invention can prevent possible health and safety risks to persons, such as children, by limiting access to the contents of the herb and spice grinder 10. The lock 22 can be a padlock, including combination and keyed lock, but could also be any other type of lock having a bolt or cable which can be inserted through the holes.

FIG. 2 shows the herb and spice grinder 10 without the lock 22 installed. In particular, it can be seen that each of the sections 12, 14 and 16 has a generally identical exterior surface. In particular, each of the sections 12, 14 and 16 is generally triangular shape and has rounded corners 26, 28 and 30. An indentation is formed in each of these rounded corners so as to facilitate the ability to grip the respective sections 12, 14 and 16 of the herb and spice grinder 10. It can be seen that there are holes 18, 32 and 34 formed adjacent to each of the rounded corners 28, 26 and 30, respectively. As such, as stated before, when the respective holes of each of the sections 12, 14 and 16 are aligned, it is possible to put the bolt of a lock therethrough so as to secure each of these sections 12, 14 and 16 together and to prevent access to the contents.

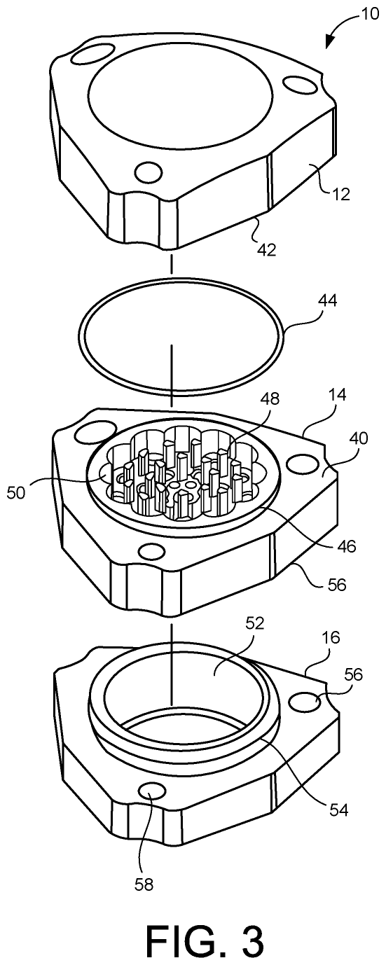

FIG. 3 is an exploded view from an upper perspective of the herb and spice grinder 10. Initially, there is a first section 12 which is a cap section. The second section 14 has a top surface 40 that will face the underside 42 of the first section 12. An O-ring 44 will fit around a shoulder 46 of the second section 14. Shoulder 46 extends upwardly for a short distance from the top surface 40. A plurality of blades 48 are positioned within a central collection pocket 50 of the second section 14. The central collection pocket 50 has a desired depth. The plurality of blades 48 will extend upwardly in spaced relation to each other within the central collection pocket 50. As will be described hereinafter, the bottom of the central collection pocket 50 has a plurality of openings or holes therethrough so as to allow the ground and shredded herbs and spices to be passed downwardly toward the third section 16.

The third section 16 is illustrated as having a receptacle 52 formed centrally thereof. Receptacle 52 has a male external thread 54 formed therearound. The male external thread 54 will engage with the female internal thread on the underside 56 of the second section 14. When the second section 14 is fully rotated so as to fully engage with the threads 54 of the third section 16, the respective holes at the corners of the second section 14 will align with the holes 56 and 58 of the third section 16.

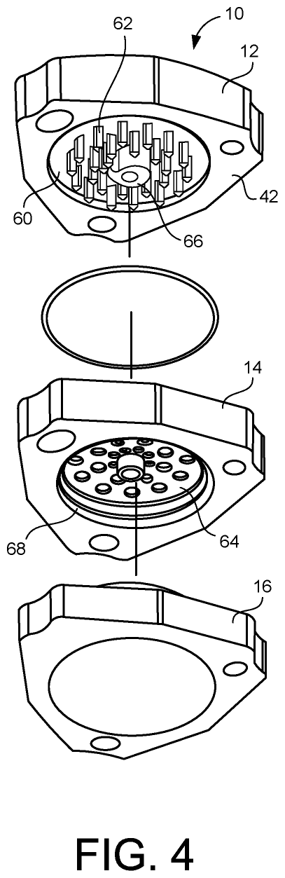

FIG. 4 shows of a perspective exploded bottom view of the herb and spice grinder of the present invention. As can be seen, the underside 42 of the first section 12 also includes a pocket 60 formed centrally thereof. Another plurality of blades 62 are affixed within the pocket 60 so as to extend outwardly therefrom. The plurality of blades 62 will engage with the plurality of blades 48 of the second section 14. When the first section 12 is rotated with respect to the second section 14, the close relationship between the blades 48 and 62 will create the necessary grinding effect and shredding effect so as to reduce the herbs and spices that may be deposited within the central collection pocket 48 of the second section 14 to a size suitable for passing through the holes 64 of the second section 14.

In FIG. 4, there is a cutter 66 affixed to a post extending downwardly within the pocket 60 of the first section 12. Cutter 66 will serve to shred material that is positioned within the central collection pocket 48 of the second section 14. The blades 48 of the second section 14 will extend in close proximity to the cutter 66 when the first section 12 is positioned onto the second section 14. As a result of this configuration, the rotation of the first section 12 with respect to the second section 14 will create a shredding effect through the use of the cutter 66 and will create a grinding effect through the close interaction of the blades 48 of the second section 14 and the blades 62 of the first section 12.

FIG. 4 shows that the second section 14 has female threads 68 formed at a bottom thereof. Female threads 68 will engage with the male threads 54 of the third section 16 so that the second section 14 is threadedly secured to the third section 16.

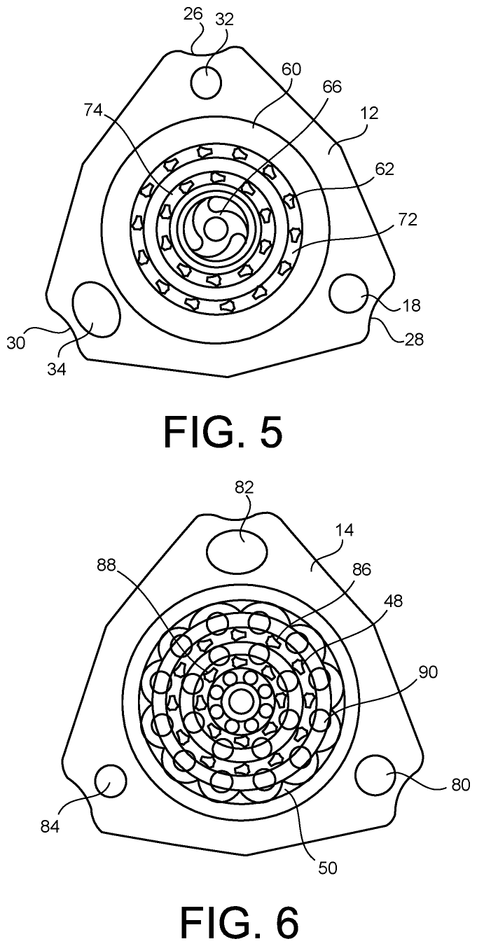

FIG. 5 is a bottom view of the first section 12. It can be seen that the first section 12 has holes 18, 32 and 34 formed at the various corners thereof. In particular, hole 18 is adjacent to the corner 28. Hole 34 is adjacent to the corner 26. Hole 34 is adjacent to the corner 30. Each of the corners 26, 28 and 30 is indented inwardly and curved. Furthermore, hole 34 has an oval shape in comparison with the round configuration of the holes 18 and 32.

FIG. 5 shows the cutter 66 as located centrally of the pocket 60. The blades 62 are arranged in a first circular array 72 and a second circular array 74. The first circular array 72 has a greater radius than the second circular array 74. Each of the blades 62 will have a configuration similar to that shown in FIG. 6. The cutter 66 is located within an interior of the second circular array 74.

FIG. 6 is a top view of the second section 14. The second section 14 includes holes 80, 82 and 84. In general, the outer periphery of the second section 14 will be identical to the outer periphery of the first section 12. In FIG. 6, it can be seen that the blades 48 are arranged in a first circular array 86 and a second circular array 88. The first circular array 86 has a greater radius than the second circular array 88. There are plurality of holes 90 that extend through the second section 14. Some of the holes are located toward the outer periphery of the central collection pocket 50. Some of the other holes are formed in a circular pattern between the first circular array of blades 86 and the second circular array of blades 88. Other holes are positioned inwardly of the second circular array of blades 88 generally adjacent to the central area that serves to receive the cutter 66. The various holes allow the ground and shredded material to be deposited, by gravity, into the third section 16.

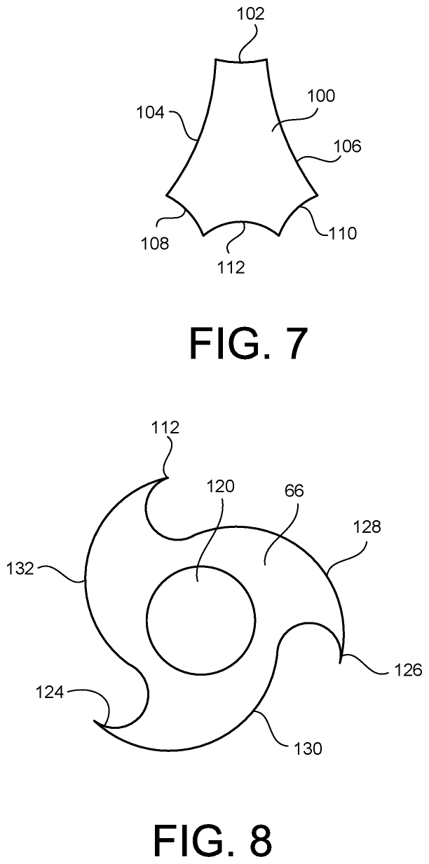

FIG. 7 shows the improved configuration of a blade 100 as used in each of the first section 12 in the second section 14 of the present invention. FIG. 7 shows a cross-sectional view of this blade 100. The blade 100 includes a first curved end surface 102, a pair of curved side surfaces 104 and 106, a pair of curved end surfaces 108 and 110 and a central curved end surface 112. The first curved end surface 102 is curved inwardly. Each of the pair of curved side surfaces 104 and 106 are also curved inwardly and extend from respective ends of the first curved end surface 102. The pair of curved end surfaces 108 and 110 also are curved inwardly. The pair of curved end surfaces 108 and 110 are opposite to the first curved end surface. Each of the curved end surface 108 extends inwardly from an end of the curved side surface 104 opposite the first curved end surface 102. Similarly, the second curved end surface 110 extends inwardly from an end of the curved side surface 106 opposite the end of the first curved end surface 102. The central curved end surface 112 is also curved inwardly and is located opposite to the first curved end surface 102 and is located between the pair of second curved end surfaces 108 and 110.

It should be noted that a width between outer edges of the pair of second curved end surfaces 108 and 110 is greater than a width of the first curved end surface 102. A radius of the central curved end surface 112 is greater than a radius of the first curved end surface 102 and greater than a radius of each of the pair of second curved end surfaces 108 and 110.

After experimentation, it was found that this configuration of cutter blades improves the cutting and grinding action of the herb and spice grinder 10 of the present invention. Each of the curved surfaces acts to create a greater pinching effect when interacting with adjacent blades so as to achieve a greater cutting and grinding effect.

The cutter 66 is illustrated in FIG. 8. The cutter 66 is mounted to a post 120 which extends downwardly from the bottom of the first section 12 and located centrally of the pocket 60. The cutter 66 has a pinwheel shape. The cutter 66 has a first pointed end 122, a second pointed end 124 and a third pointed end 126. There is a first S-shaped edge 128 that extends between the pointed ends 122 and 126. Another S-shape edge 130 extends between pointed end 124 and pointed end 126. A third S-shape edge 132 extends between the pointed end 122 and the pointed end 124. This curvature facilitates the ability to shred the herbs and spices there would be placed into the herb and spice grinder of the present invention.

The foregoing disclosure and description of the present invention is illustrative and explanatory thereof. Various changes in the details of the illustrated construction can be made within the scope of the appended claims without departing from the true spirit of the invention. The present invention should only be limited by the following claims and their legal equivalents.

I claim:

1. An herb and spice grinder comprising:
a first section having a first plurality of blades on a bottom side thereof;
a second section removably connected to said bottom side of said first section, said second section having a central collection pocket with a second plurality of blades therein, said second plurality of blades extending upwardly toward said first section; and
a third section removably connected to a bottom side of said second section, said third section having a receptacle formed therein, each of the first, second third sections having a hole formed therethrough, the holes of the first, second and third sections being alignable so as to allow for the receipt of a lock member therethrough.

2. The herb and spice grinder of claim 1, said third section being threadedly connected to said second section.

3. The herb and spice grinder of claim 1, said first section having a recess formed in said bottom side thereof, said central collection pocket of said second section having a shoulder extending upwardly therefrom, wherein an O-ring is interposed between said shoulder of said second section and a wall of said recess of said first section.

4. The herb and spice grinder of claim 1, further comprising:
a plurality of openings formed through said central collection pocket, said plurality of openings located adjacent said second plurality of blades.

5. The herb and spice grinder of claim 1, wherein the first, second and third sections each have a generally triangular shape with rounded corners.

6. The herb and spice grinder of claim 5, wherein a hole is formed adjacent each of the rounded corners of each of the first, second and third sections.

7. The herb and spice grinder of claim 6, wherein one hole of each of the first, second and third sections is oval-shaped.

8. The herb and spice grinder of claim 5, wherein an indentation is formed at each of the rounded corners of each of the first, second and third sections.

9. The herb and spice grinder of claim 1, further comprising:
a cutter positioned centrally of said first plurality of blades of said first section, said cutter having a pinwheel shape.

10. The herb and spice grinder of claim 9, wherein said cutter, in cross-section, has three pointed ends with an S-shaped edge extending respectively between the three pointed ends.

11. The herb and spice grinder of claim 1, each of said first plurality of blades and second plurality of blades comprising:
a longitudinal member having a cross-section having a first curved end surface, a pair of curved side surfaces extending from ends of the first curved end surface, a pair of second curved end surfaces extending inwardly from the ends of the pair of curved side surfaces, and a central curved end surface positioned between the pair of second curved end surfaces.

12. The herb and spice grinder of claim 1, wherein:
said first plurality of blades of said first section comprises a first circular array and a second circular array spaced apart from the first circular array, and
said second plurality of blades of said second section comprises a first circular array and a second circular array spaced apart from the first circular array, said second plurality of blades of said second section intermeshing with said first plurality of blades of said first section.

13. An herb and spice grinder comprising:
a plurality of sections that are removably connected together, said plurality of sections defining an interior for grinding and storage of the herb or spice, each of the plurality of sections having a hole formed therethrough, the holes of the plurality of sections being alignable so as to form a passageway through said plurality of sections; and
a lock having a bolt, said bolt being received in said passageway so as to prevent access to said interior of said plurality of sections.

14. The herb and spice grinder of claim 13, said plurality of sections comprising:
a first cap section;
a second section having a plurality of openings formed therethrough; and
a third section having a receptacle formed therein.

15. The herb and spice grinder of claim 14, further comprising:
a first plurality of blades formed on a bottom side of said first cap section; and
a second plurality of blades formed on a top side of said second section, said first plurality of blades intermeshing with said second plurality of blades.

16. The herb and spice grinder of claim 14, said third section being threadedly engaged with said second section.

17. The herb and spice grinder of claim 14, said first cap section having a recess formed in said bottom thereof, said second section having a shoulder extending upwardly therefrom, wherein an O-ring is interposed between said shoulder of said second section and a wall of said recess of said first cap section, said first cap section being rotatable relative to said second section.

18. The herb and spice grinder of claim 13, each of said plurality of sections comprising:
a generally-triangular member having rounded corners, wherein each rounded corner has a curved indentation, and wherein said hole of each of the plurality of sections comprises a hole positioned adjacent each of the rounded corners.

19. The herb and spice grinder of claim 13, said lock comprising a padlock.

20. A blade for an herb and spice grinder comprising:
a longitudinal member having a cross-section having a first curved end surface, a pair of curved side surfaces extending from ends of the first curved end surface, a pair of second curved end surfaces extending inwardly from the ends of the pair of curved side surfaces, and a central curved end surface positioned between the pair of second curved end surfaces.
